(19) United States
(12) Patent Application Publication
(10) Pub. No.: US 2025/0237246 A1
(43) Pub. Date: Jul. 24, 2025

(54) TWO-PIECE FASTENER FOR REMOVABLY ATTACHING TWO ARTICLES

(71) Applicant: George Goebel, Montclair, NJ (US)

(72) Inventor: George Goebel, Montclair, NJ (US)

(21) Appl. No.: 19/025,758

(22) Filed: Jan. 16, 2025

Related U.S. Application Data
(60) Provisional application No. 63/623,114, filed on Jan. 19, 2024.

(51) Int. Cl. F16B 2/22

(52) U.S. Cl. CPC F16B 2/22

(57) ABSTRACT

A two-piece fastener comprising a clip and clip receiver. The clip is designed to slide onto the clip receiver whereby the clip and clip receiver become engaged. The engagement between the clip and clip receiver is sufficient to maintain the attachment of the two despite the introduction of large external forces while allowing a user to disengage the clip from the clip receiver by applying a modest separation force and a lateral force to the clip along a line of insertion of the clip onto the clip receiver. The clip incorporates one or more stops. The clip receiver is a block member defining a clip insertion space. In practice, the clip slides over a raised intermediate section of the clip receiver so that the one or more stops are received by one or more openings on a spine in the block member whereby the clip and clip receiver become engaged.

### CROSS-REFERENCES

This application claims priority to U.S. Patent Application No. 63/623,114 filed Jan. 19, 2024 which is incorporated herein for all purposes.

### FIELD OF THE INVENTION

The embodiments of the present invention relate to a two-piece fastener configured to removably attach two articles to one another.

### BACKGROUND

Two-piece fasteners for removably attaching articles to one another are not a new idea. Hook and loop fasteners, snaps and nuts and bolts are but a few examples of two-piece fasteners. Nonetheless, there remain many instances where a new two-piece fastener is more suitable to removably attach two articles.

Accordingly, it would be beneficial to develop a new, easy-to-use two-piece fastener for removably attaching two articles.

### SUMMARY

The embodiments of the present invention include a two-piece fastener comprising a clip and clip receiver. The clip is designed to slide into the clip receiver such that the clip and clip receiver become engaged. The engagement between the clip and clip receiver is sufficient to maintain the attachment of the two despite the introduction of large external forces while allowing a user to disengage the clip from the clip receiver by applying a modest separation force between the clip and clip receiver and a lateral force to the clip along a line of insertion of the clip into the clip receiver.

In one embodiment, the clip is a belt or spring clip modified to incorporate one or more stops. In one embodiment, the clip receiver is a block member comprising two support legs and a raised intermediate section defining a clip insertion space. With these embodiments, the clip slides over the raised intermediate section so that the one or more stops are received by one or more openings on the raised intermediate section in the block member so that the clip and clip receiver become engaged.

Other variations, embodiments and features of the present invention will become evident from the following detailed description, drawings and claims.

### BRIEF DESCRIPTION OF THE DRAWINGS

FIGS. 1A to 1C illustrate upper perspective, top down and side views, respectively, of a prior art belt or spring clip of type suitable for the embodiments of the present invention;

FIGS. 2A and 2B illustrate an upper perspective view and side view, respectively, of a clip according to the embodiments of the present invention;

FIG. 3 illustrates an upper perspective view of a clip receiver according to the embodiments of the present invention;

FIG. 4 illustrate a bottom perspective view of the clip receiver according to the embodiments of the present invention;

FIG. 5 illustrates an end view of the clip receiver according to the embodiments of the present invention; and

FIG. 6 illustrates a second side view of the clip receiver according to the embodiments of the present invention; and

FIGS. 7A to 7F illustrate the clip and clip receiver being engaged according to the embodiments of the present invention.

### DETAILED DESCRIPTION

For purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the components detailed below can be fabricated of suitable materials including plastics, composites, metals, alloys, glasses, polymers and the like as well as combinations thereof. Those skilled in the art will further recognize that the components detailed below can be fabricated using suitable methods including injection molding, machining, additive processing, casting and the like as well as combinations thereof.

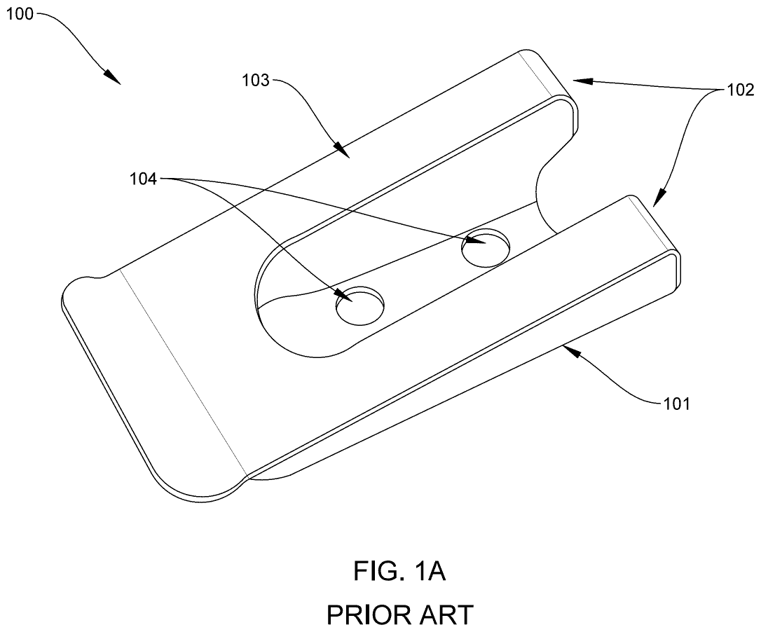

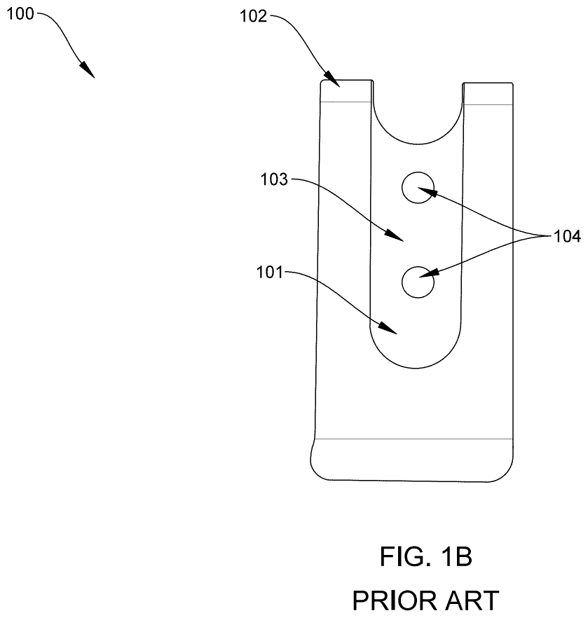

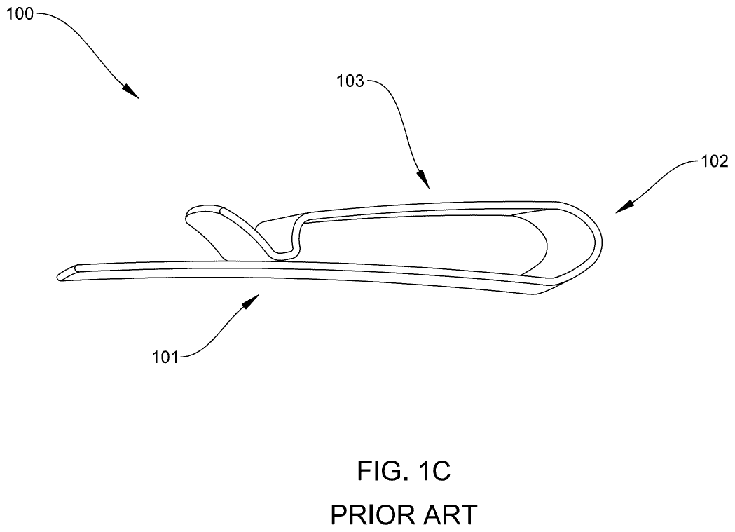

FIGS. 1A to 1C show a belt or spring clip 100 (“clip”) according to the prior art. Such clips are normally formed from a single piece of metal (e.g., spring steel) that returns to an original shape despite being deflected or twisted. As shown, such clips have a support section 101, bend section 102 and flex section 103. One or more openings 104 in the support section 101 are used to attach the clip to an article (e.g., tape measure) that is to use the clip 101 to attach to a belt or similar article.

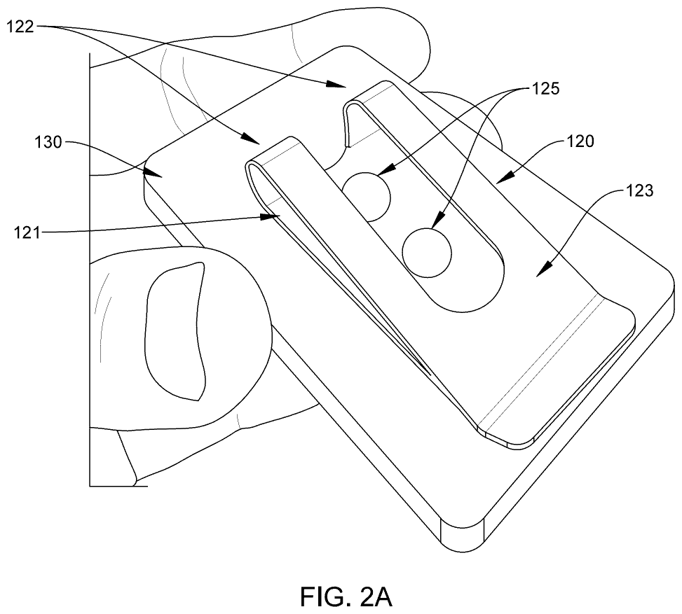

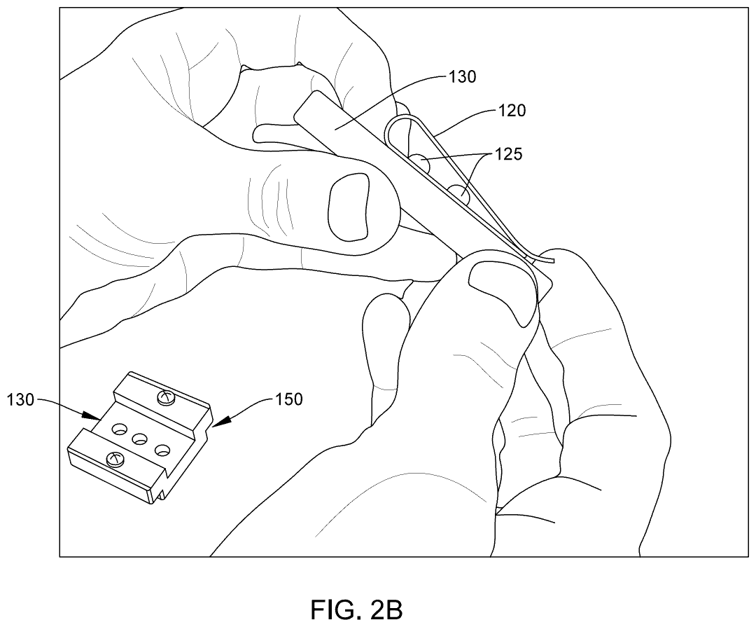

FIGS. 2A and 2B show a clip 120 used with the embodiments of the present invention. The clip 120, like the prior art clips, includes a support section 121, bend section 122 and flex section 123. The clip 120 further includes a pair of stops 125. In this instance, the stops 125 comprise rivets which are used to attach the clip 120 to a support member 130. The support member 130 (represented by a piece of plexi-glass) may be any rigid material (e.g., plastic, drywall, etc.) or pliable material (e.g., cloth) that is able to receive the stops 125 to secure said clip 100 thereto. In an alternative embodiment, the support member 130 may not be required if the clip 130 is attached directly to a subject article for which attachment to another article is desired. As shown, the rivets 125 have rounded tops which, as detailed below, serve to facilitate engagement and disengagement of the clip 100 from a clip receiver 150. Those skilled in the art will recognize that connectors (e.g., rounded screws), other than rivets, may also be used as the stops 125.

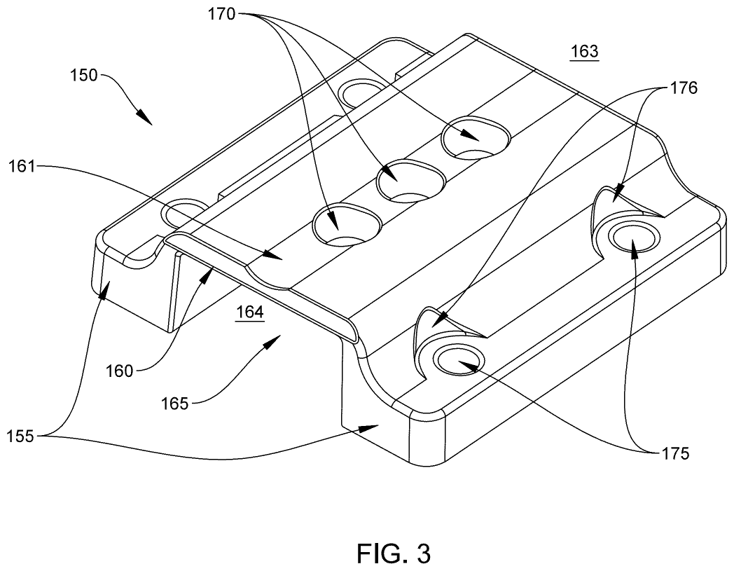

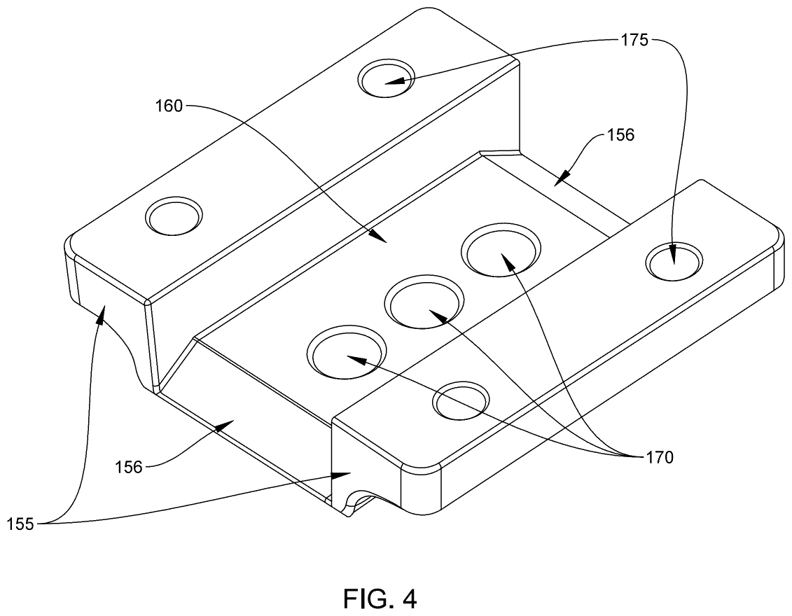

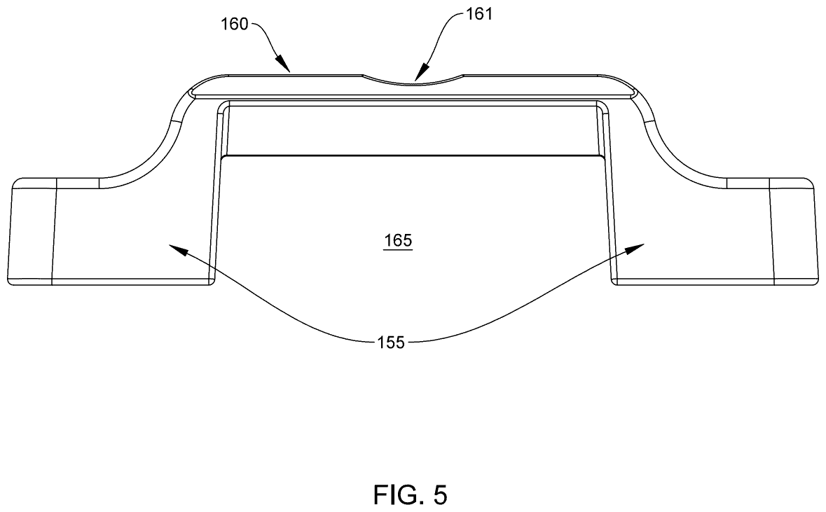

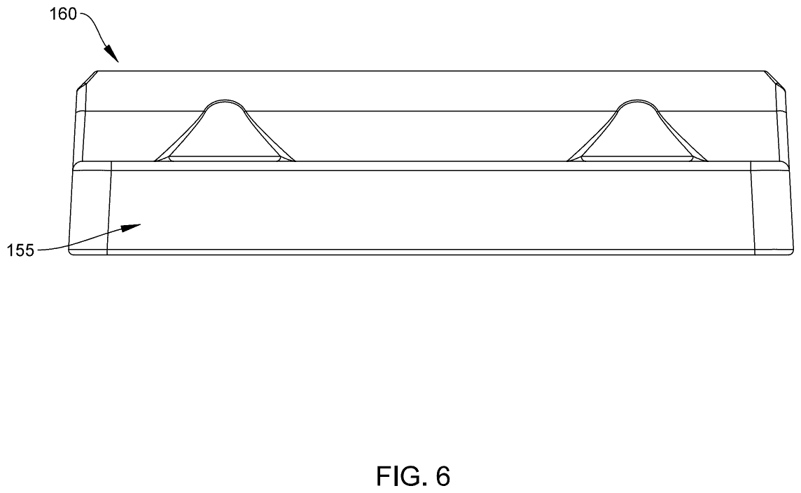

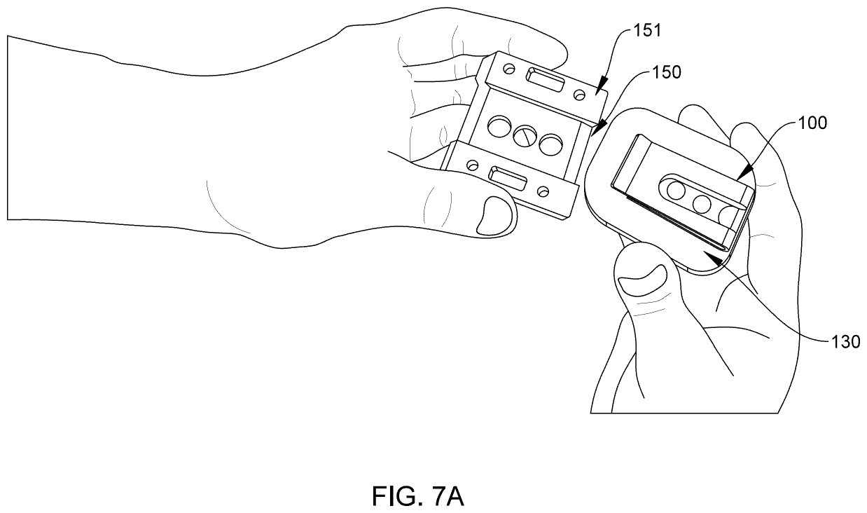

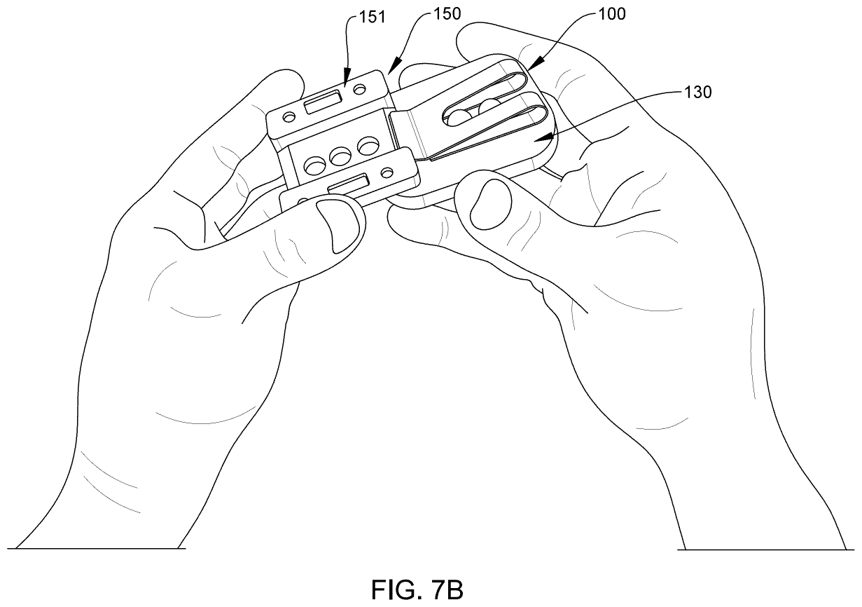

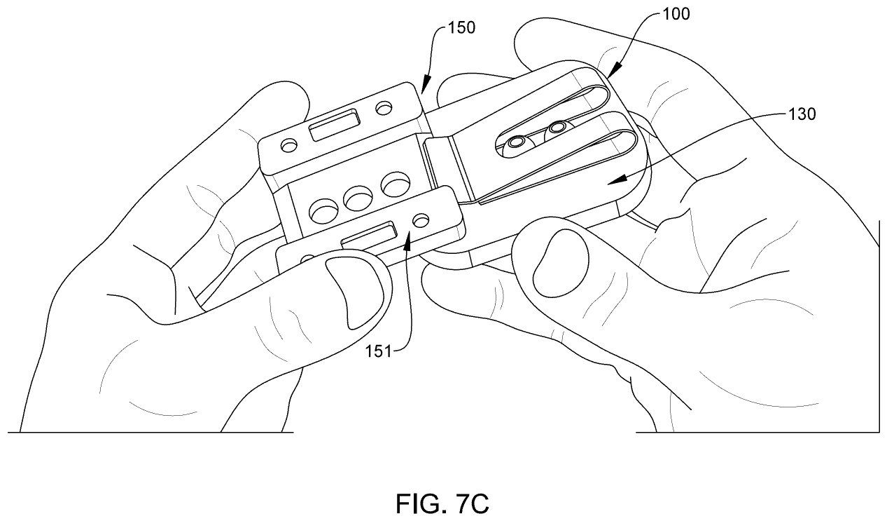

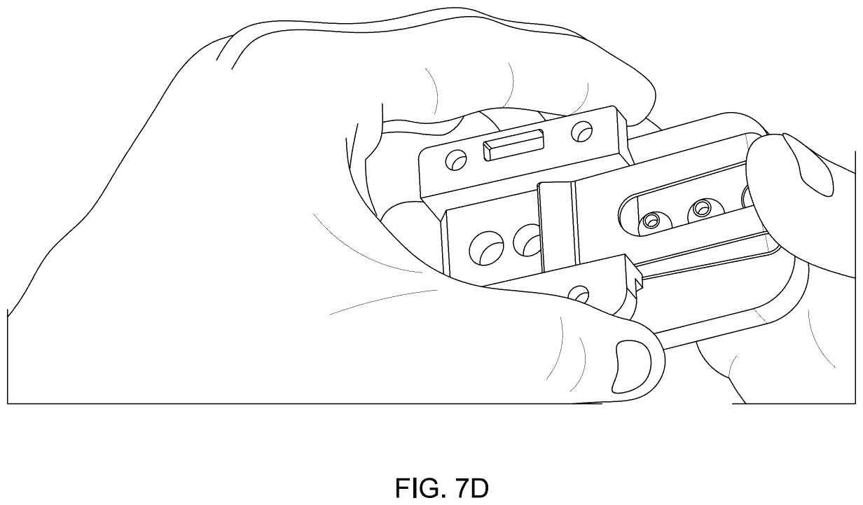

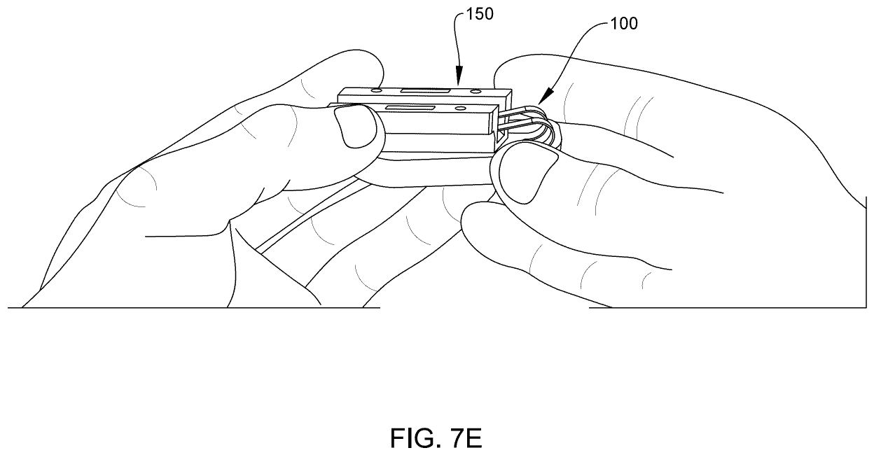

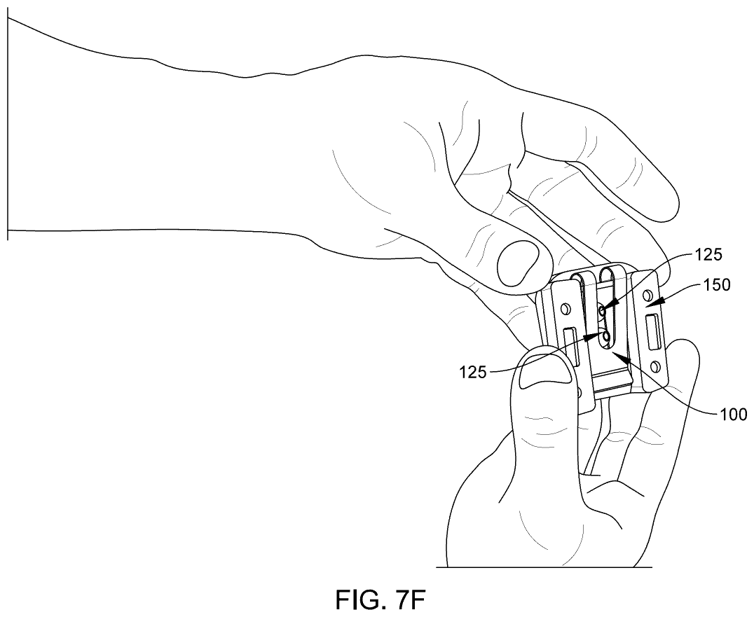

FIGS. 3 to 6 show the clip receiver 150 according to the embodiments of the present invention. Clip receiver 150 comprises two support legs 155 spaced by a raised intermediate section 160. The two support legs 155 and raised intermediate section 160 define a clip receiving space 165. The raised intermediate section 160 includes openings 170. The openings 170 may or may not extend completely through the raised intermediate section 160. For reasons that will be apparent, as shown best in FIGS. 3 and 6, an upper surface of the intermediate section 160 includes a groove 161, encompassing openings 170, along its length. Openings 175 are used to receive screws or other members to connect the clip receiver 150 to a first article 151 (represented by a piece of plexi-glass) to which the clip 100 is used to connect a second article. Cutouts 176 provide space for the screws or other members. As best shown in FIG. 4, the underside of the raised intermediate section 160 includes ramps 156 at both open ends. The ramps 156 serve, as shown in FIGS. 7C through 7E, to guide the flex section 123 of the clip 120 to slide into the clip receiving space 165 while the support section 121 and stops 125 slide along the upper side of the raised intermediate section 160 so that said stops 125 may engage or protrude into the openings 170.

FIGS. 7A to 7F show the engagement of the clip 100 to the clip receiver 150. The clip 100 slips onto the clip receiver 150 such that the flex section 123 extends into the clip receiving space 165 while the support section 121 and stops 125 slide along the upper surface of the raised intermediate section 160 so that the one or more stops 125 are received by the one or more openings 170 thereby engaging the clip 100 and the clip receiver 150. The groove 161 serves to receive and guide the stops 125 to the one or more openings 170. The clip receiver 150 is configured such that the clip 100 may slide onto the raised intermediate section 160 from either end 163, 164.

In practice, the two-piece fastener may be used to connect two articles. For example, the clip 100 may be connected to a first article—golf-swing training device—and the clip receiver 150 may be attached to a second article—body strap—so that the golf-swing training device—can be attached to the body strap worn by the golfer. Those skilled in the art will recognize that the two-piece fastener described herein may be used to connect any two articles to one another. The two-piece fastener is also useful for attaching an article to a rigid member. For example, attaching one or more clip receivers 150 to a wall allows a myriad articles (e.g., tools, televisions, shelves, etc.) to be mounted thereto. With a television, for example, two clip receivers 150 may be spaced and attached to a wall vertically, via the wall's supporting studs, while two clips 100 may be spaced and attached to the rear of the television allowing the two clips 100 to be slid down onto the two clip receivers 150 thereby mounting the television on the wall. Removal of the television involves lifting the television to disengage the two clips 100 from the two clip receivers 150.

Although the invention has been described in detail with reference to several embodiments, additional variations and modifications exist within the scope and spirit of the invention.

I claim:

1. A fastener, comprising:
a clip, said clip including one or more stops;
a clip receiver comprising two support legs connected by a raised intermediate section, said raised intermediate section including one or more openings; and
wherein said one or more openings receive said one or more stops when said clip is slid over said raised intermediate section.

2. The fastener of claim 1 further comprising a clip support.

3. The fastener of claim 1 further comprising a groove along an upper surface of said raised intermediate section, said groove encompassing said one or more openings.

4. The fastener of claim 1 wherein said one or more stops connect said clip to a support member.

5. The fastener of claim 1 wherein said one or more stops are rounded rivets.

6. The fastener of claim 1 wherein said clip comprises a support section, bend section and flex section.

7. The fastener of claim 1 wherein said one or more openings extend through raised intermediate section.

8. The fastener of claim 1 wherein said raised intermediate section includes ramps at both ends on an underside thereof.

9. A fastener, comprising:
a spring-biased clip having a flex section, said clip including one or more stops;
a clip receiver comprising two support legs connected by a raised intermediate section, said raised intermediate section including one or more openings; and
wherein said one or more openings receive said one or more stops when said clip is slid over said raised intermediate section such that said flex section is received by a clip receiving space defined by said raised intermediate section.

10. The fastener of claim 9 further comprising a clip support.

11. The fastener of claim 9 further comprising a groove along an upper surface of said raised intermediate section, said groove encompassing said one or more openings.

12. The fastener of claim 9 wherein said one or more stops connect said clip to a support member.

13. The fastener of claim 9 wherein said one or more stops are rounded rivets.

14. The fastener of claim 9 wherein said clip further comprises a support section and bend section.

15. The fastener of claim 9 wherein said one or more openings extend through raised intermediate section.

16. The fastener of claim 9 wherein said raised intermediate section includes ramps at both ends on an underside thereof.

17. A clip, comprising:
a spring-biased clip member including a support section, bend section and flex section, said spring biased-clip member attachable to a first article; and
wherein said support section includes one or more stops configured to protrude into one or more openings in a second article to which said spring-biased clip member is slid onto thereby removably attaching said first article to said second article.

18. The clip of claim 17 wherein said second article is a clip receiver comprising two support legs connected by a raised intermediate section, said raised intermediate section including said one or more openings.

19. The clip of claim 18 wherein said one or more openings receive said one or more stops when said clip is slid over said raised intermediate section such that said flex section is received by a clip receiving space defined by said raised intermediate section.

20. The clip of claim 17 wherein a groove along an upper surface of said raised intermediate section includes said one or more openings.

21. The clip of claim 17 wherein said one or more stops connect said spring-biased clip member to a support member.

22. The clip of claim 17 wherein said one or more stops are rounded rivets.

23. The clip of claim 18 wherein said raised intermediate section includes ramps at both ends on an underside thereof.
